(19) United States
(12) Patent Application Publication
(10) Pub. No.: US 2009/0014916 A1
(43) Pub. Date: Jan. 15, 2009

(54) METHOD AND APPARATUS FOR PRODUCING THREE-DIMENSIONAL STRUCTURE

(75) Inventors: Hisao Nagai, Osaka (JP); Hidehiro Yoshida, Osaka (JP); Takayuki Furukawa, Osaka (JP); Takashi Inoue, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/815,054

(22) PCT Filed: Nov. 13, 2006
(86) PCT No.: PCT/JP2006/322572

§ 371 Date: Jul. 30, 2007

(30) Foreign Application Priority Data
Dec. 1, 2005 (JP) 2005-347613

(51) Int. Cl. B29C 41/08; B05B 13/02

(52) U.S. Cl. 264/401; 425/174.4

(57) ABSTRACT

The present invention aims to produce a three-dimensional structure having a high aspect ratio by using inkjet printing techniques or the like. Specifically, a three-dimensional structure is produced by ejecting a liquid drop of a solution, which contains a solvent and polymer particles dispersed in the solvent while having a viscosity of not more than 100 cps, from a nozzle onto a substrate; then evaporating the solvent and melting the polymer particles by irradiating the liquid drop with light; and then depositing the molten polymer particles on the substrate. The present invention can be applied to production of biochips and the like.

### TECHNICAL FIELD

The present invention relates to a method and apparatus for producing a three-dimensional structure.

The present invention is characterized in using an inkjet printing technique or the like in which a light irradiation mechanism is used to spray droplets that include polymer particles.

### BACKGROUND ART

The development of biosensor devices such as DNA chips and immune analysis chips has been proceeded for the purposes of separating and detecting various components in blood that include glucose and the like, or for separating DNA (deoxyribonucleic acid) components. A pillar having a diameter on the nano meter or micro meter level and a height of several hundred micrometers is formed in these devices. Accordingly, a technique for forming a three-dimensional structure (including a nanopillar or a micropillar) having a high aspect ratio is essential to the fabrication of such a device.

In the conventional technique for forming a three-dimensional structure having a high aspect ratio, a nano-imprinting technique (for example, hot embossing) or other techniques is used to transfer a micro-size or nano-size shape to a polymer resin or photocurable resin (see Patent Document 1, for example). A pillar having a high aspect ratio is formed in a die used in these methods, but a technique is required for fabricating a die with a minute shape in order to form a pillar having a high aspect ratio. Accordingly, a technique is needed for achieving a high aspect ratio in the machining of metal, quartz or other die materials that is difficult to machine.

When a three-dimensional structure is produced by a nano-imprinting technique, a minute die must be newly fabricated each time the design of the three-dimensional structure is modified. Fabrication of a minute die requires time and cost, and is also technically difficult. Furthermore, numerous varieties of dies must be fabricated for device prototypes having a large number of design modifications, or for limited production of diversified products, and it is therefore sometimes inappropriate to use a nano-imprinting technique. In the die separation process according to a nano-imprinting technique, the amount of force needed to separate the die is larger for the higher aspect ratio of the produced three-dimensional structure. Therefore, it is difficult to separate the die with high accuracy without collapsing the microasperity of the produced three-dimensional structure having a high aspect ratio. For example, it is sometimes extremely difficult to form a nanopillar whose aspect ratio is 3 or higher using the nano-imprinting technique.

An inkjet printing technique is known as a technique for creating minute patterning directly on a substrate (see Patent Document 2, for example). This technique has advantages in that the desired two-dimensional shape can be formed inexpensively and in a short time by causing a material to be sprayed from each of a plurality of horizontally aligned inkjet nozzles in a scanning action.

A minute die such as the one used in a nano-imprinting technique is not needed, and therefore an inkjet printing technique is suitable for limited production of diversified products. However, the material sprayed from the inkjet nozzles is limited to a low viscosity (about 1 to 10 cps, for example). The discharged material disperses on the substrate after coming into contact with the substrate, and therefore the discharged material cannot be deposited, and a shape having a high aspect ratio is difficult to form. This technique therefore cannot be utilized to produce three-dimensional structures such as nanopillars and micropillars.

Patent Document 1: Japanese Patent Application Laid-open No. 2004-288783

Patent Document 2: Japanese Patent Application Laid-open

### DISCLOSURE OF INVENTION

### Problems to be Solved by the Invention

As described above, the conventional nano-imprinting technique requires a large number of minute dies, and can therefore be unsuitable for limited production of diversified products, or for device prototypes having a large number of design modifications. Furthermore production of minute dies could itself be difficult. Although the conventional inkjet printing technique is readily adaptable to design modifications and is capable of forming a two-dimensional shape in a short time, the materials that can be discharged from the nozzles are limited to low-viscosity materials. A low-viscosity material spreads horizontally on the substrate, and therefore the material cannot be deposited three-dimensionally, and a three-dimensional structure is difficult to produce using the inkjet printing technique.

It is therefore an object of the present invention to produce a three-dimensional structure having an arbitrary shape using an inkjet printing technique or the like. The invention thereby provides a method and apparatus for producing a three-dimensional structure that are capable of readily adapting to design modifications of a three-dimensional structure having a high aspect ratio.

### Means for Solving the Problem

The inventors discovered that a three-dimensional structure in the desired shape can be produced by utilizing an inkjet printing technique or the like that uses a light irradiation mechanism to discharge droplets of a solution having a viscosity of 100 cps or lower in which polymer particles are dispersed. Specifically, the present invention is characterized in that droplets of a solution discharged from a nozzle are irradiated with light before coming in contact with a substrate, the solvent in the droplets is evaporated, and the polymer particles included in the droplets are melted to increase the viscosity. The present invention is based on the knowledge that the desired three-dimensional structure can be produced by bringing the viscosity-enhanced droplets into contact with the substrate, fixing the droplets to the substrate, and continuously depositing droplets to build up a solid object.

Specifically, a first aspect of the present invention relates to the method described below for producing a three-dimensional structure.

(1) A method for producing a three-dimensional structure, having the steps of:

discharging droplets of a solution that includes a solvent and polymer particles dispersed in the solvent and has a viscosity of 100 cps or lower from a nozzle to a substrate;

radiating light to the droplets to evaporate the solvent included in the droplets, and to melt the polymer particles included in the droplets; and

depositing the molten polymer particles onto the substrate.

(2) The producing method according to (1), wherein the discharge i's performed by a piezoelectric inkjet.
(3) The producing method according to (1) or (2), wherein light is radiated to the droplets before the droplets come into contact with the substrate.
(4) The producing method according to any of (1) through (3), wherein the light is infrared rays or ultra violet rays.
(5) The producing method according to any of (1) through (4), wherein the light is laser light.
(6) The producing method according to any of (1) through (5), wherein the light is radiated to the droplets from the direction of the nozzle or from beside the nozzle.
(7) The producing method according to any of (1) through (6), wherein the viscosity of the droplets is changed to 100 cps or higher by the radiation of the light.
(8) The producing method according to any of (1) through (7), wherein the substrate or the nozzle is arbitrarily moved in an XYZ direction.
(9) The producing method according to any of (1) through (8), wherein an average particle size of the polymer particles is 1 μm or less.
(10) The producing method according to any of (1) through (9), wherein the polymer particles are hollow particles.
(11) The producing method according to any of (1) through (10), wherein the polymer particles include two or more groups of particles having different sizes.
(12) The producing method according to any of (1) through (11), wherein the three-dimensional structure is a pillar.

A second aspect of the present invention relates to the apparatus described below for producing a three-dimensional structure.

(13) An apparatus for producing a three-dimensional structure, having: a nozzle that discharges droplets of a solution that includes a solvent and polymer particles dispersed in the solvent towards a substrate; a vibration part that vibrates the solution; a light source that radiates light to the droplets of a solution discharged from the nozzle; and a drive mechanism that moves the nozzle or the substrate in an XYZ direction, wherein the light source is disposed above or beside a discharge port of the nozzle.
(14) The apparatus for producing a three-dimensional structure according to (13), wherein the light source is an infrared laser or an infrared-radiating apparatus.
(15) The apparatus for producing a three-dimensional structure according to (13), wherein the light source is an ultra violet laser or an ultra violet-radiating apparatus.
(16) The apparatus for producing a three-dimensional structure according to any of (13) through (15), further having a section that vibrates the substrate or the light source.

### ADVANTAGEOUS EFFECT OF THE INVENTION

The method for producing a three-dimensional structure according to the present invention makes it possible to readily produce an arbitrary three-dimensional structure, and readily adapt to design modifications of a three-dimensional structure.

### BRIEF DESCRIPTION OF DRAWINGS

FIG. 1 is a schematic view of the apparatus for producing a three-dimensional structure according to Embodiment 1;

FIG. 2 is a schematic view of the apparatus for producing a three-dimensional structure according to Embodiment 2;

FIG. 3 is a schematic view of the apparatus for producing a three-dimensional structure according to Embodiment 3; and

FIG. 4 is a schematic view of the apparatus for producing a three-dimensional structure according to Embodiment 4.

### BEST MODE FOR CARRYING OUT THE INVENTION

1. Method for producing a three-dimensional structure according to the present invention

The method for producing a three-dimensional structure includes the steps of (1) discharging droplets of a solution including a solvent and polymer particles dispersed in the solvent from a nozzle to a substrate; (2) radiating light to the droplets and melting the polymer particles included in the droplets; and (3) depositing the molten polymer particles onto the substrate.

In the producing method of the present invention, the viscosity of the solution that includes polymer particles is preferably 100 cps or lower, more preferably lower than 100 cps, and ideally 10 cps or lower. This viscosity allows droplets of the solution to be appropriately discharged from the nozzle. The viscosity of the solution may be calculated by a common viscosity measurement method. For example, a shear speed may be inputted, and the viscosity may be calculated from the outputted shear stress, and a (rotating) rheometer may be used to measure the viscosity. The method for discharging the droplets will be described herein after.

It is preferable that droplets accommodated in an inkjet head or the like are vibrated and discharged from the nozzle.

The components of the polymer particles included in the solution are not particularly limited, and examples thereof include polyethylene terephthalate, polyacrylic ester, polystyrene, polybutadiene, polyethylene, and the like. The glass transition temperature or melting point of the polymer particles is preferably 90° C. or lower, because the polymer particles included in the discharged droplets are more easily melted when irradiated with light. As described herein after, the polymer particles and the substrate may be formed using the same material.

The average particle size of the polymer particles is preferably 1 μm or less, and more preferably 0.5 μm or less. Such an average particle size is needed in order to produce a minute three-dimensional structure (for example, a nanopillar or a micropillar). The particle size of the polymer particles in the solution is measured, for example, as an area-equivalent diameter using an image processing method.

The polymer particles may be hollow particles. Heat is not easily transferred to the insides of solid particles, and, when a solid particle whose inside is not melted is deposited on the substrate, the particle may be inappropriately deposited, and the desired three-dimensional structure is sometimes impossible to produce. On the other hand heat is evenly transferred to a hollow particle, and the heat of the radiated light can be confined inside the particle, and therefore the particle can be melted by low-energy light.

The polymer particles may be a combination of two or more groups of particles having different particle sizes. In other words, the particle size distribution of the polymer particles included in the solution may have two or more peaks. Combining particles of different diameters makes it possible to obtain a solution that has a lower viscosity in comparison with a solution that includes particles having the same particles size even when the particle content is the same as that of the solution that includes particles having the same particle size. Reducing the viscosity makes it possible to prevent the discharge port of the nozzle from clogging.

The particle nuclei and the particle coatings may be composed of different substances in the polymer particles. For example, a nucleus composed of a polymer having a low glass transition temperature may be coated with a polymer having a high glass transition temperature, or a nucleus composed of a polymer having a high glass transition temperature may be coated with a polymer having a low glass transition temperature.

The polymer particles are preferably evenly dispersed in the solvent. Accordingly, a polymer material for preventing the polymer particles from settling may be physically adsorbed or chemically adsorbed on the periphery of the polymer particles.

The concentration of the polymer particles in the solution is adjusted so as to give the solution a viscosity of 100 cps or lower, and may be about 50 vol % to 95 vol %.

The solvent in the solution that includes the polymer particles may be a water-based solvent or an organic solvent, but the solvent preferably has water or a low-boiling alcohol as the main component thereof. The boiling point of the solvent is preferably 60° C. or lower so that the solvent is evaporated by radiating light to droplets of the solution discharged from the nozzle.

The solution is discharged in the form of droplets from the nozzle to the substrate. The nozzle is a nozzle of an inkjet head, a nozzle of a dispenser, or the like. The area of the discharge port of the nozzle is selected according to the shape of the three-dimensional structure to be produced. For example the diameter of the discharge port is about 40 μm to 200 μm when the discharge port is circular.

The droplets are discharged from the nozzle of an inkjet head, or the nozzle of a dispenser, but an inkjet is preferable. For example, a droplet is preferably discharged from the nozzle through high-speed vibration of the solution accommodated in the inkjet head. This vibration can be created using a piezoelectric (piezo) element. In other words, the droplets are preferably discharged by a piezoelectric inkjet. Droplets are repeatedly discharged as pulses.

The quantity (per pulse) of droplets discharged from the nozzle is appropriately selected according to the shape of the three-dimensional structure to be produced. The quantity of about 3 pl to 20 pl is preferable. The quantity of droplets is adjusted according to the area of the nozzle discharge port, the degree of vibration of the solution, the viscosity of the solution, and other characteristics.

Examples of the material for forming the substrate on which the droplets are discharged are the same as the above-described examples of the material for forming the polymer particles, and include polyethylene terephthalate, polyacrylic ester, polystyrene, polybutadiene, polyethylene, and the like. The materials used to form the substrate and the polymer particles are not necessarily limited, but are preferably the same. The three-dimensional structure produced by the present invention may be applied as a biotip or the like. When the substrate and the polymer particles are composed of the same material, chemical reactions on the three-dimensional structure can be easily controlled and stabilized.

The radiation of light to the droplets discharged from the nozzle evaporates the solvent and melts the polymer particles. The viscosity of the droplets is thereby increased. The viscosity of the irradiated droplets is preferably 100 cps or higher. The light is radiated before the droplets discharged from the nozzle come into contact with the substrate. The high-viscosity droplets that include molten polymer particles and reach the substrate do not easily disperse thereon, and can be solidified in place. A three-dimensional structure formed from the polymer is produced by continuously depositing and solidifying the high-viscosity liquid on the polymer particles that are solidified on the substrate.

Examples of the above-described light include infrared rays and ultra violet rays. The light may also be laser light, and the droplets can be efficiently heated when a laser light is used. The radiating laser light is not particularly limited. For example, a YAG laser light, a semiconductor laser light, an ultra violet laser light, or other laser light may be used.

The laser light may be radiated to the droplets as collimated light, or the focal point may be caused to coincide with the droplets in the irradiation. This is done in order to more efficiently heat the droplets. The radiation output of the laser light may also be adjusted to control the viscosity of the droplets after irradiation. Furthermore, the radiation output of the laser light may be varied for each discharged droplet. For example, the output of the laser light radiated to a subsequently discharged droplet may be incrementally increased so as to be higher than the output of the laser light radiated to the initially discharged droplet. The stress load of the produced three-dimensional structure can be reduced by varying the hardness of the upper part (portion deposited later) with respect to the lower part (portion deposited first) of the three-dimensional structure.

The light may be radiated from any direction with respect to the discharged droplets. In other words, the light may be radiated from the direction of the nozzle, from beside the nozzle, or from the direction of the substrate. The light is preferably radiated from the direction of the nozzle or from beside the nozzle.

The molten polymer particles included in the droplets from which the solvent is removed by irradiation are cooled and solidified after reaching the substrate. The viscosity of the droplets is increased, and therefore the droplets are made less likely to disperse on the substrate. A three-dimensional structure can be produced by continuously depositing the molten polymer particles.

The molten polymer particles that reach the substrate may be further irradiated with light. Accordingly, polymer particles reaching the substrate need not be completely melted and the solvent need not be completely removed. In this case the polymer particles on the substrate are preferably irradiated with light.

In the above-described depositing, the substrate or the nozzle may be arbitrarily moved in three dimensions to produce a three-dimensional structure that has the desired shape. For example, an arbitrary shape is formed by mounting the substrate on a table that is capable of moving in three dimensions, or by moving the nozzle and the substrate through the use of a rotation mechanism and a simultaneous advance mechanism, respectively.

The light source or the substrate may also be finely vibrated. The droplets can thereby be evenly irradiated with light.

An arbitrary three-dimensional structure is produced by the method of the present invention, and the three-dimensional structure may be a pillar, for example. The pillar may have a width of several hundred nanometers to several hundred micrometers, and a height of 1 to 100 μm. Furthermore, the pillar preferably has an aspect ratio (height/width) of 1 or higher. The produced pillar is sometimes curved mid-length, or has an inverse tapered shape.

A space divided by a rib or the like may be provided to the substrate, and the polymer particles may be deposited in the space. A larger three-dimensional structure can be produced by removing the rib after depositing the particles. The rib for providing a space may be formed from a resist material, for example.

The producing method of the present invention can be applied to producing biotip and the like, but is not particularly limited.

2. Apparatus for Producing the Three-Dimensional Structure According to the Present Invention

The above-described method for producing a three-dimensional structure can be implemented using the producing apparatus described below. The apparatus for producing a three-dimensional structure according to the present invention has a nozzle that discharges droplets of a solution that includes polymer particles towards a substrate; a vibration part that vibrates the solution; a light source that radiates light to droplets of a solution discharged from the nozzle; and a drive mechanism that moves the nozzle or the substrate in an XYZ direction.

The nozzle of the producing apparatus of the present invention may be a nozzle of an inkjet head or a nozzle of a dispenser. The solution that includes the polymer particles is accommodated in the inkjet head or dispenser head.

The vibration part includes a piezoelectric element, for example. A piezoelectric element, also called piezo element, is a ceramic that changes shape when voltage is applied. A voltage is applied to a piezoelectric element placed in the inkjet or other devices for accommodating the solution that includes the polymer particles, and the solution is thereby vibrated. The structure of the piezoelectric element is not particularly limited. The piezoelectric element may be a piezoelectric plate or a laminated piezo element.

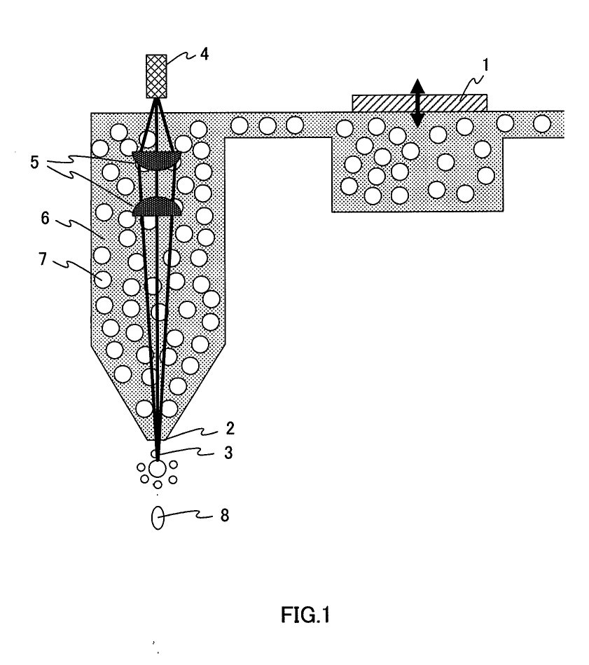

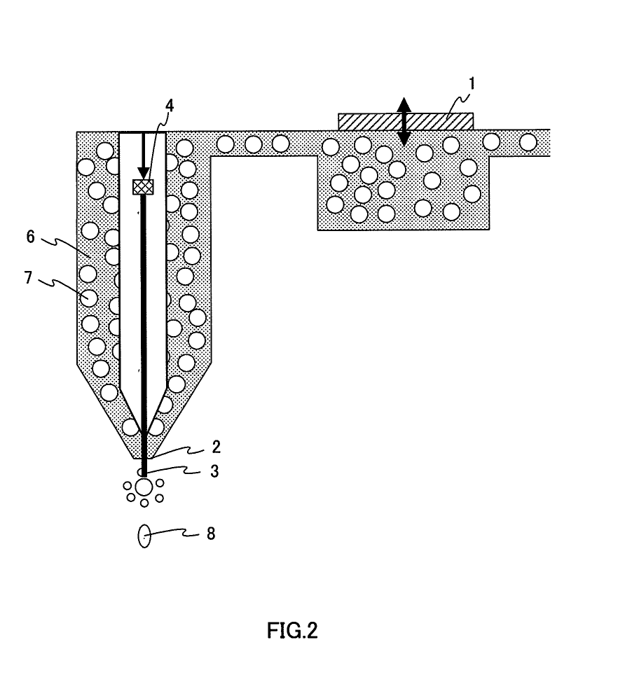

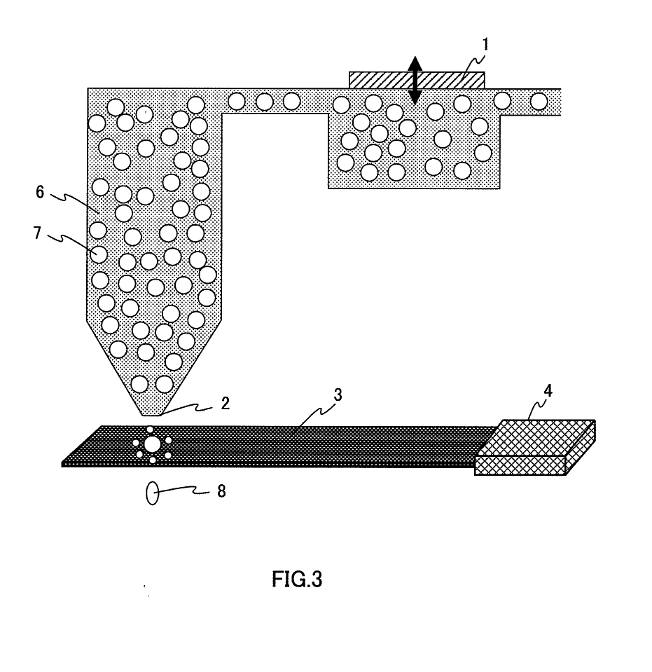

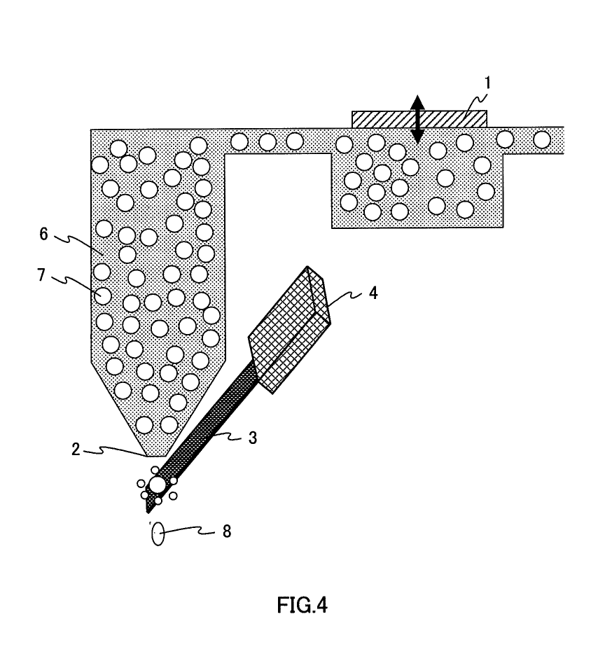

The light source may be an apparatus for emitting ultra violet rays or infrared rays, but a laser light is preferable. When the light source is a laser, the laser may have a convex lens for collimating the laser light. The laser may also have a condensing lens for causing the focal point to coincide with a droplet. The light source may be disposed above the nozzle (see FIGS. 1 and 2) or beside the nozzle (see FIGS. 3 and 4). It is considered easier to radiate the laser light to a droplet when the light source is disposed above the nozzle, and the apparatus can also be made compact. The structure of the inkjet or other heads is simplified when the light source is placed beside the nozzle, and therefore the cost of the apparatus may also decrease. A light source that is disposed beside the nozzle may also be easier to vibrate.

The drive mechanism includes, for example, a member that enables a table on which the substrate is mounted to be moved in three dimensions, or a combination of a rotation mechanism and a simultaneous advance mechanism that may be applied to the nozzle and the substrate, respectively.

Embodiments of the present invention will be described below with reference to the accompanying drawings.

### EMBODIMENT 1

FIG. 1 shows an example of the inkjet head that is a component of the apparatus for producing a three-dimensional structure. The reference numeral 1 indicates a piezoelectric element, 2 indicates a nozzle, 3 indicates laser light, 4 indicates a laser, 5 indicates a lens, 6 indicates a solvent, 7 indicates a polymer particle, and 8 indicates a high-viscosity droplet.

Piezoelectric element 1 vibrates at high speed, and thereby solvent 6 and polymer particle 7 are discharged in the form of a droplet from nozzle 2. Laser light 3 is emitted from laser 4 (for example, YAG laser, semiconductor laser, and ultra violet laser). Laser light 3 passes through lens 5 and changes to collimated light, and the focal point of laser light 3 converted to collimated light is caused to coincide with the discharged droplet.

The discharged droplet is heated by the condensed laser light, the solvent is evaporated, and the polymer particle included in the droplet is melted. The droplet is thereby changed to high-viscosity droplet 8 after being discharged from the nozzle. High-viscosity droplet 8 is cooled and changed from liquid to solid after reaching the surface (substrate) on which the three-dimensional structure is being produced. A three-dimensional structure can thus be produced by continuously depositing the solids obtained by converting high-viscosity droplets 8.

A three-dimensional structure having an arbitrary shape may be produced by mounting the substrate on a table that is capable of moving in three dimensions, or by moving the nozzle and the substrate through the use of a rotation mechanism and a simultaneous advance mechanism (not shown), respectively. It is also preferable that the light source or the substrate is capable of fine vibration so as to evenly irradiate an entire droplet.

FIG. 1 shows an example in which an inkjet is used, but a dispenser or the like may also be used instead of an inkjet.

### EMBODIMENT 2

FIG. 2 shows another example of the inkjet head that is a component of the apparatus for producing a three-dimensional structure. In FIG. 2, components that are the same as those in FIG. 1 will be assigned the same reference numerals without further explanations.

A droplet of a solution that includes polymer particle 7 described above is discharged through the high-speed vibration of piezoelectric element 1 placed at an inkjet head. Laser 4 is mounted inside a cylinder placed in the center of the inkjet head. The cylinder is configured so that the solution cannot enter into the cylinder.

Gas may be released from the cylinder provided inside the inkjet in order to accelerate discharge of the solution. The gas may also be heated in order to change the viscosity of the discharged droplet.

When the discharged droplet is irradiated with laser light 3, the solvent (water, for example) is evaporated, the polymer particle included in the droplet is heated, and the polymer particle is melted from a solid to a high-viscosity liquid. The high-viscosity liquid is cooled and changed from liquid to solid after reaching the surface on which the three-dimensional structure is formed. A three-dimensional structure can thus be produced by depositing a solid obtained by converting a high-viscosity liquid to a solid.

In the same way as in Embodiment 1, a three-dimensional structure having an arbitrary shape may be produced by mounting the substrate on a table that is capable of moving in three dimensions, or by moving the nozzle and the substrate through the use of a rotation mechanism and a simultaneous advance mechanism (not shown), respectively. It is also preferable that the light source or the substrate is capable of fine vibration so as to evenly irradiate an entire droplet.

### EMBODIMENT 3

FIGS. 3 and 4 show other examples of the inkjet head unit that is an apparatus for producing a three-dimensional structure according to the present invention. In FIGS. 3 and 4, components that are the same as those in FIG. 1 will be assigned the same reference numerals without further explanations.

A droplet of a solution that includes polymer particle 7 previously described can be discharged by making piezoelectric element 1 inside the inkjet vibrate at high speed. Laser 4 is mounted outside the inkjet head. The laser is mounted substantially horizontal to the nozzle in FIG. 3, and above the nozzle at an angle in FIG. 4. The discharged polymer particles are easily irradiated when laser light 3 is planar as shown in the drawing.

At this time, the laser light may be condensed and the droplet including the polymer particle may be irradiated from the side. When the discharged droplet is irradiated with laser light 3, the solvent water is evaporated, and the polymer particle included in the solution is converted from solid to liquid. The high-viscosity liquid is cooled and changed from liquid to solid after reaching the surface on which the three-dimensional structure is formed. A three-dimensional structure can thus be produced by depositing a solid obtained by converting a high-viscosity liquid to a solid.

In the same way as in Embodiment 1, a three-dimensional structure having an arbitrary shape may be produced by mounting the substrate on a table that is capable of moving in three dimensions, or by moving the nozzle and the substrate through the use of a rotation mechanism and a simultaneous advance mechanism (not shown), respectively. It is also preferable that the light source or the substrate is capable of fine vibration so as to evenly irradiate an entire droplet.

### INDUSTRIAL APPLICABILITY

The present invention makes it possible to readily produce a nanopillar, a micropillar, or other three-dimensional structures having a high aspect ratio. The present invention can thus be applied to producing biosensor devices such as DNA separation and immune analysis chips; optical devices such as microlenses and polarization elements; and photonic crystals and the like.

The present application is based on Japanese Patent Application No. 2005-347613, filed on Dec. 1, 2005, the entire content of which is incorporated by reference herein.

1. A method for producing a three-dimensional structure, comprising the steps of:
discharging droplets of a solution that includes a solvent and polymer particles dispersed in the solvent and has a viscosity of 100 cps or lower from a nozzle to a substrate;
radiating light to the droplets to evaporate the solvent included in the droplets, and to melt the polymer particles included in the droplets; and
depositing the molten polymer particles onto the substrate.

2. The producing method according to claim 1, wherein the discharge is performed by a piezoelectric inkjet.

3. The producing method according to claim 1, wherein light is radiated to the droplets before the droplets come into contact with the substrate.

4. The producing method according to claim 1, wherein the light is infrared rays or ultra violet rays.

5. The producing method according to claim 1, wherein the light is laser light.

6. The producing method according to claim 1, wherein the light is radiated to the droplets from the direction of the nozzle or from beside the nozzle.

7. The producing method according to claim 1, wherein the viscosity of the droplets is changed to 100 cps or higher by the radiation of the light.

8. The producing method according to claim 1, wherein the substrate or the nozzle is arbitrarily moved in an XYZ direction.

9. The producing method according to claim 1, wherein an average particle size of the polymer particles is 1 μm or less.

10. The producing method according to claim 1, wherein the polymer particles are hollow particles.

11. The producing method according to claim 1, wherein the polymer particles include two or more groups of particles having different sizes.

12. The producing method according to claim 1, wherein the three-dimensional structure is a pillar.

13. An apparatus for producing a three-dimensional structure, comprising:
a nozzle that discharges droplets of a solution that includes a solvent and polymer particles dispersed in the solvent towards a substrate;
a vibration part that vibrates the solution;
a light source that radiates light to the droplets of a solution discharged from the nozzle; and
a drive mechanism that moves the nozzle or the substrate in an XYZ direction,
wherein the light source is disposed above or beside a discharge port of the nozzle.

14. The apparatus for producing a three-dimensional structure according to claim 13, wherein the light source is an infrared laser or an infrared-radiating apparatus.

15. The apparatus for producing a three-dimensional structure according to claim 13, wherein the light source is an ultra violet laser or an ultra violet-radiating apparatus.

16. The apparatus for producing a three-dimensional structure according to claim 13, further comprising a section that vibrates the substrate or the light source.
